(19) United States
(12) Patent Application Publication
(10) Pub. No.: US 2021/0176679 A1
(43) Pub. Date: Jun. 10, 2021

(54) METHOD AND APPARATUS FOR TRANSMITTING INFORMATION

(71) Applicant: GUANGDONG OPPO MOBILE TELECOMMUNICATIONS CORP., LTD., Dongguan (CN)

(72) Inventors: Shukun WANG, Dongguan (CN); Ning YANG, Dongguan (CN)

(21) Appl. No.: 17/179,051

(22) Filed: Feb. 18, 2021

Related U.S. Application Data
(63) Continuation of application No. PCT/CN2018/103919, filed on Sep. 4, 2018.

(51) Int. Cl. H04W 36/00; H04W 76/30; H04W 76/11

(52) U.S. Cl. CPC H04W 36/0079; H04W 36/00835; H04W 84/042; H04W 76/30; H04W 76/11; H04W 36/0077

(57) ABSTRACT

A method and apparatus for transmitting information are provided. The method includes the following. A terminal device acquires first configuration information for redirection, and searches for a target cell based on the first configuration information. The terminal device records reference information when the terminal device fails to find a first target cell which matches the first configuration information, where the reference information includes at least one of: the first configuration information, identity (ID) information of a second target cell found by the terminal device, location information of the terminal device, timestamp information corresponding to the recording, signal quality of a serving cell, and signal quality of a neighbor cell of the serving cell. The terminal device sends the recorded reference information to a network side.

### CROSS REFERENCE TO RELATED APPLICATION(S)

This application is a continuation of International Application No. PCT/CN2018/103919, filed on Sep. 4, 2018, the entire disclosure of which is incorporated herein by reference.

### TECHNICAL FIELD

This application relates to the technical field of mobile communication, and more particularly to a method and apparatus for transmitting information and a terminal device.

### BACKGROUND

In order to meet people's pursuit of service speed, delay, high-speed mobility, and energy efficiency, as well as diversity and complexity of business in future life, the international standard organization of 3rd generation partnership project (3GPP) began to develop the 5th generation (5G) mobile communication technology.

An air interface part of the 5G mobile communication technology is referred to as a new radio (NR). In an early deployment of the NR, it is difficult to achieve a complete NR coverage. Therefore, a typical network coverage is a combination of long term evolution (LTE) coverage and NR coverage. In addition, in order to protect an early investment of mobile operators in LTE, a tight interworking mode between the LTE and the NR is proposed. NR cells can also be deployed independently.

When a user equipment (UE) is moving, the UE can be switched to a target cell through handover or redirection. However, both the LTE and the NR fail to solve a problem of redirection failure.

### SUMMARY

In a first aspect, a method for transmitting information is provided. The method includes the following. A terminal device acquires first configuration information for redirection, and searches for a target cell based on the first configuration information. The terminal device records reference information when the terminal device fails to find a first target cell which matches the first configuration information, where the reference information includes at least one of: the first configuration information, identity (ID) information of a second target cell found by the terminal device, location information of the terminal device, timestamp information corresponding to the recording, signal quality of a serving cell, and signal quality of a neighbor cell of the serving cell. The terminal device sends the recorded reference information to a network side.

In a second aspect, an apparatus for transmitting information is provided. The apparatus is applicable to a terminal device. The apparatus includes at least one processor, a transceiver, and a memory. The memory is configured to store instructions which, when executed by the at least one processor, cause the at least one processor to: acquire, through the transceiver, first configuration information for redirection; search for a target cell based on the first configuration information; record reference information when failing to find a first target cell which matches the first configuration information, where the reference information includes at least one of: the first configuration information, ID information of a second target cell found by the terminal device, location information of the terminal device, timestamp information corresponding to the recording, signal quality of a serving cell, and signal quality of a neighbor cell of the serving cell; send, through the transceiver, the recorded reference information to a network side.

In a third aspect, a method for transmitting information is provided. The method is applicable to a network side and includes the following. The network side transmits first configuration information for redirection to a terminal device, wherein the first configuration information is used for the terminal device to search for a first target cell that matches the first configuration information. The network side receives reference information from the terminal device, where the reference information is recorded at the terminal device when the terminal device fails to find the first target cell, where the reference information includes at least one of: the first configuration information, identity (ID) information of a second target cell found by the terminal device, location information of the terminal device, timestamp information corresponding to the recording, signal quality of a serving cell, and signal quality of a neighbor cell of the serving cell.

### BRIEF DESCRIPTION OF THE DRAWINGS

The drawings described herein are used to provide a further understanding of implementations and constitute a part of the disclosure. Exemplary implementations of the disclosure and the descriptions thereof are used to explain the disclosure, and do not constitute an improper limitation on the disclosure. In the drawings:

FIG. 1 is a schematic diagram of an architecture of a communication system according to implementations.

FIG. 2 is a schematic flowchart of a method for transmitting information according to implementations.

FIG. 3 is a schematic structural diagram of an apparatus for transmitting information according to implementations.

FIG. 4 is a schematic flowchart of a method for transmitting information according to implementations.

FIG. 5 is a schematic structural diagram of a communication device according to implementations.

FIG. 6 is a schematic structural diagram of a chip according to implementations.

FIG. 7 is a schematic block diagram of a communication system according to implementations.

### DETAILED DESCRIPTION

The following will describe technical solutions of implementations with reference to the accompanying drawings. Apparently, implementations described herein are merely some implementations, rather than all implementations, of the disclosure. Based on the implementations described herein, all other implementations obtained by those of ordinary skill in the art without creative effort shall fall within the protection scope of the disclosure.

The technical solutions of implementations are applicable to various communication systems, for example, a global system of mobile communication (GSM), a code division multiple access (CDMA) system, a wideband code division multiple access (WCDMA) system, a general packet radio service (GPRS) system, a long term evolution (LTE) system, an LTE frequency division duplex (LTE-FDD) system, an LTE time division duplex (LTE-TDD) system, a universal mobile telecommunication system (UMTS), a worldwide interoperability for microwave access (WiMAX) communication system, or a 5G system.

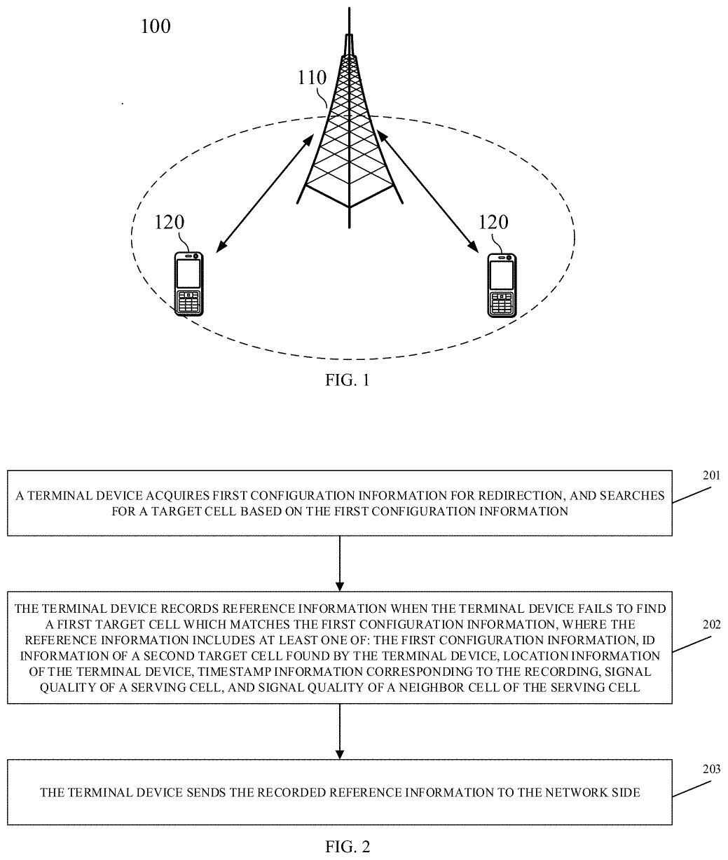

FIG. 1 is a schematic diagram of an architecture of a communication system according to implementations. As illustrated in FIG. 1, the communication system 100 may include a network device 110. The network device 110 may be a device that can communicate with a terminal device 120 (also referred to as “communication terminal” or “terminal”). The network device 110 can provide a communication coverage for a specific geographical area and communicate with terminal devices in the coverage area. The network device 110 may be a base transceiver station (BTS) in the GSM or in the CDMA system, or may be a NodeB (NB) in the WCDMA system, or may be an evolutional Node B (eNB or eNodeB) in the LTE system, or a radio controller in a cloud radio access network (CRAN). Alternatively, the network device may be a mobile switching center, a relay station, an access point, an in-vehicle device, a wearable device, a hub, a switch, a bridge, a router, a network-side device in a 5G network, or a network device in a future evolved public land mobile network (PLMN).

The communication system 100 further includes at least one terminal device 120 located in the coverage area of the network device 110. The “terminal device” referred to herein can include but is not limited to a device configured to communicate via a wired line, another data connection/network, a wireless interface, a device which is part of another terminal device and configured to receive/transmit communication signals, and/or an Internet of things (IoT) device. Examples of the wired line may include, but are not limited to, a public switched telephone network (PSTN), a digital subscriber line (DSL), a digital cable, and a direct connection cable. Examples of the wireless interface may include, but are not limited to, a wireless interface for a cellular network, a wireless local area network (WLAN), a digital television network (such as a digital video broadcasting-handheld (DVB-H) network), a satellite network, and an amplitude modulation-frequency modulation (AM-FM) broadcast transmitter. A terminal device configured to communicate via a wireless interface may be called a “wireless communication terminal”, a “wireless terminal”, or a “mobile terminal”. Examples of a mobile terminal may include, but are not limited to, a satellite telephone or cellular telephone, a personal communication system (PCS) terminal integrated with functions of cellular radio telephone, data processing, fax, and/or data communication, a personal digital assistant (PDA) equipped with radio telephone, pager, Internet/Intranet access, web browsing, notebook, calendar, and/or global positioning system (GPS) receiver, and/or a conventional laptop, a handheld receiver, or other electronic devices equipped with radio telephone receiver. The terminal device may refer to an access terminal, a UE, a subscriber unit, a subscriber station, a mobile station, a remote station, a remote terminal, a mobile device, a user terminal, a terminal, a wireless communication device, a user agent, or a user device. The access terminal may be a cellular radio telephone, a cordless telephone, a session initiation protocol (SIP) telephone, a wireless local loop (WLL) station, a PDA, a handheld device with wireless communication functions, a computing device, other processing devices coupled with a wireless modem, an in-vehicle device, a wearable device, a terminal device in the 5G network, a terminal device in the future evolved PLMN, etc.

As an example, terminal devices 120 can communicate with each other through device to device (D2D) communication.

As an example, the 5G system or 5G network can also be referred to as an NR system or NR network.

FIG. 1 exemplarily illustrates one network device and two terminal devices. The communication system 100 may also include multiple network devices, and there can be other numbers of terminal devices in a coverage area of each of the network devices, which is not limited herein.

The communication system 100 may further include other network entities such as a network controller, a mobile management entity, or the like, and the disclosure is not limited in this regard.

According to implementations, a device with communication functions in a network/system can be referred to as a “communication device”. Taking the communication system 100 illustrated in FIG. 1 as an example, the communication device may include the network device 110 and the terminal device(s) 120 that have communication functions. The network device 110 and the terminal device(s) 120 can be the devices described above and will not be repeated herein. The communication device may further include other devices such as a network controller, a mobile management entity, or other network entities in the communication system 100, and the disclosure is not limited in this regard.

It should be understood that, the terms “system” and “network” herein are usually used interchangeably throughout this disclosure. The term “and/or” herein only describes an association relationship between associated objects, which means that there can be three relationships. For example, A and/or B can mean A alone, both A and B exist, and B alone. In addition, the character “/” herein, unless otherwise specified, generally indicates that the associated objects are in an “or” relationship.

The technical solutions in implementations are mainly applied to a 5G mobile communication system. However, technical solutions provided herein are not only applicable to the 5G mobile communication system, and can also be applied to other types of mobile communication systems. The following describes the main application scenarios in the 5G mobile communication system.

1) eMBB scenario: eMBB aims to obtain multimedia content, services, and data for users and grows rapidly in business demands. Because eMBB may be deployed in different scenarios, such as indoor, urban, rural, etc., its service capabilities and requirements vary widely, and it is necessary to analyze the service in combination with specific deployment scenarios.

2) URLLC scenario: Typical applications of URLLC include: industrial automation, power automation, telemedicine operations, and traffic safety assurance.

3) mMTC scenario: URLLC is typically characterized by: high connection density, small amount of data, delay-insensitive services, low cost of modules, and long service life.

In release 15 (R15) NR, a maximum channel bandwidth of each NR carrier is 100 MHz for a low frequency and 400 MHz for a high frequency, and the 100 MHz/400 MHz channel bandwidth is continuous. If a UE remains operating on a broadband carrier, power consumption of the UE is high, and therefore, it is desirable that a radio frequency (RF) bandwidth of the UE is adjusted according to a practical throughput of the UE.

In LTE, self organizing network (SON) defines many network-side optimization functions, for example, mobility robustness optimization (MRO), random access optimization (RO), automatic neighbor relation (ANR), and minimization of drive tests (MDT).

In NR, only ANR is supported. For a scenario in which a UE is moving, the UE can be switched to a target cell through handover or redirection. However, in LTE, there is currently no solution to the failure in redirection, and therefore, it is necessary to optimize the solution of mobility failure in LTE and NR.

FIG. 2 is a schematic flowchart of a method for transmitting information according to implementations. As illustrated in FIG. 2, the method includes the following.

At block 201, a terminal device acquires first configuration information for redirection, and searches for a target cell based on the first configuration information.

According to implementations, the terminal device may be any device that can communicate with a network, such as a mobile phone, a tablet computer, an in-vehicle terminal device, a notebook computer, etc.

In some implementations, the terminal device can acquire the first configuration information for redirection as follows. The terminal device receives a radio resource control (RRC) connection release message from the serving cell, where the RRC connection release message carries the first configuration information for redirection.

In some implementations, the first configuration information includes at least one of: radio access type (RAT) information of the target cell, frequency information of the target cell, identity (ID) information of the target cell, and system broadcast information of the target cell.

A network side (that is, the serving cell) determines that a UE needs to be redirected, issues the RRC connection release message to the UE, and carries, in the RRC connection release message, the first configuration information for redirection. The first configuration information includes at least one type of information of the target cell: RAT information, frequency information, ID information, and system broadcast information.

Upon receiving the RRC connection release message, the terminal device can acquire the first configuration information from the RRC connection release message.

At block 202, the terminal device records reference information when the terminal device fails to find a first target cell which matches the first configuration information, where the reference information includes at least one of: the first configuration information, ID information of a second target cell found by the terminal device, location information of the terminal device, timestamp information corresponding to the recording, signal quality of a serving cell, and signal quality of a neighbor cell of the serving cell.

According to implementations, after acquiring the first configuration information, the terminal device searches for the target cell according to the first configuration information. If the terminal device fails to find the first target cell which matches the first configuration information (that is, fails to find a cell that meets network requirements), the terminal device records at least one type of the reference information: the first configuration information, the ID information of the second target cell found by the terminal device (that is, ID information of a new target cell found by the terminal device), the location information of the terminal device, the timestamp information corresponding to the recording, the signal quality of a serving cell, and the signal quality of a neighbor cell of the serving cell.

According to implementations, the serving cell refers to a cell that is currently providing services to the terminal device. The target cell refers to a cell that the terminal device needs to be redirected to.

The following will elaborate various types of the reference information recorded by the terminal device.

1) The first configuration information: The first configuration information includes at least one of: the RAT information of the target cell, the frequency information of the target cell, the ID information of the target cell, and the system broadcast information of the target cell.

2) The ID information of the second target cell found by the terminal device: Here, the second target cell may be a target cell that satisfies the most conditions required in the first configuration information. For example, the first configuration information includes two conditions (i.e., RAT information of the target cell and the frequency information of the target cell). If the terminal device fails to find a target cell that satisfies both of the two conditions, and finds cell A and cell B that each satisfy the condition in terms of the frequency information, the terminal device selects, between cell A and cell B, the cell that has a higher signal quality as the second target cell.

In some implementations, the ID information of the second target cell includes at least one of: cell identifier (CID), physical cell identifier (PCI), RAT, frequency, and PLMN list.

3) The location information of the terminal device: The location information of the terminal device includes at least one of: geographical location information of the terminal device, and measurement results for neighbor cells of the serving cell. The geographical location information of the terminal device includes at least one of: longitude information, latitude information, and altitude information.

Here, the location information of the terminal device can be estimated according to the measurement results for neighbor cells of the present serving cell of the terminal device.

4) The timestamp information corresponding to the recording: The timestamp information includes at least one of: absolute time information local to the terminal device when the terminal device records the reference information, and relative time information relative to a reference time when the terminal device records the reference information, where the reference time is configured at the network side.

For example, the terminal device locally has its own clock which represents the absolute time information local to the terminal device. The absolute time information local to different terminal devices may be different (considering factors such as time difference). When the terminal device records the reference information, the terminal device can record the absolute time information local to the terminal device.

For another example, the network side has its own clock. The network side may send its own clock, at a certain time point (such as t), to the terminal device as the reference time. The terminal device, upon receiving the reference time t, starts timing. When the terminal device records the reference information, the terminal device records a current time, and the current time is relative time information relative to time point t.

5) The signal quality of a serving cell and/or the signal quality of a neighbor cell of the serving cell: The signal quality includes at least one of: reference signal receiving power (RSRP), reference signal receiving quality (RSRQ), and signal to interference plus noise ratio (SINR).

At block 203, the terminal device sends the recorded reference information to the network side.

In some implementations, the first configuration information further includes duration information of a first timer. The method further includes the following. The terminal device starts the first timer, after acquiring the first configuration information.

In some implementations, when the terminal device fails to find, before the first timer expires, a target cell that can be connected, the method further includes the following. The terminal device enters an idle state (also referred to as residing state) rather than establishing an RRC connection, even if the terminal device finds, after the first timer expires, the target cell that can be connected.

In some implementations, after entering an RRC connected state, the terminal device sends the recorded reference information to the network side. The network side, upon receiving the reference information from the terminal device, sends the reference information to a processing unit as input for network side optimization. The network side can perform self-optimization based on a large quantity of results reported by the terminal device(s), which is conducive to network health.

It should be noted that, the above technical solutions are described with respect to redirection. The technical solutions of implementations can also be applied to handover scenarios, which shall also fall within the protection scope of the disclosure.

FIG. 3 is a schematic structural diagram of an apparatus for transmitting information according to implementations. The apparatus is applicable to a terminal device. As illustrated in FIG. 3, the apparatus includes an acquiring unit 301, a searching unit 302, a recording unit 303, and a sending unit 304. The acquiring unit 301 is configured to acquire first configuration information for redirection. The searching unit 302 is configured to search for a target cell based on the first configuration information. The recording unit 303 is configured to record reference information when the searching unit fails to find a first target cell which matches the first configuration information, where the reference information includes at least one of: the first configuration information, ID information of a second target cell found by the terminal device, location information of the terminal device, timestamp information corresponding to the recording, signal quality of a serving cell, and signal quality of a neighbor cell of the serving cell. The sending unit 304 is configured to send the recorded reference information to a network side.

In some implementations, the acquiring unit 301 is configured to receive an RRC connection release message from the serving cell, where the RRC connection release message carries the first configuration information for redirection.

In some implementations, the first configuration information includes at least one of: RAT information of the target cell, frequency information of the target cell, ID information of the target cell, and system broadcast information of the target cell.

In some implementations, the ID information of the second target cell includes at least one of: CID, PCI, RAT, frequency, and PLMN list.

In some implementations, the location information of the terminal device includes at least one of: geographical location information of the terminal device, and measurement results for neighbor cells of the serving cell.

In some implementations, the geographical location information of the terminal device includes at least one of: longitude information, latitude information, and altitude information.

In some implementations, the timestamp information includes at least one of: absolute time information local to the terminal device when the terminal device records the reference information, and relative time information relative to a reference time when the terminal device records the reference information, where the reference time is configured at the network side.

In some implementations, the signal quality of a serving cell includes at least one of: RSRP, RSRQ, and SINR.

In some implementations, the signal quality of a neighbor cell of the serving cell includes at least one of: RSRP, RSRQ, and SINR.

In some implementations, the first configuration information further includes duration information of a first timer. The first timer is started after the acquiring unit 301 acquires the first configuration information.

In some implementations, when the searching unit fails to find, before the first timer expires, a target cell that can be connected, the terminal device enters an idle state, even if the searching unit finds, after the first timer expires, the target cell that can be connected.

In some implementations, the sending unit 304 is configured to send the recorded reference information to the network side, after the terminal device enters an RRC connected state.

Those of ordinary skill in the art should understand that, for details of the apparatus for transmitting information, reference can be made to the related description of the method for transmitting information in the foregoing method implementations for understanding.

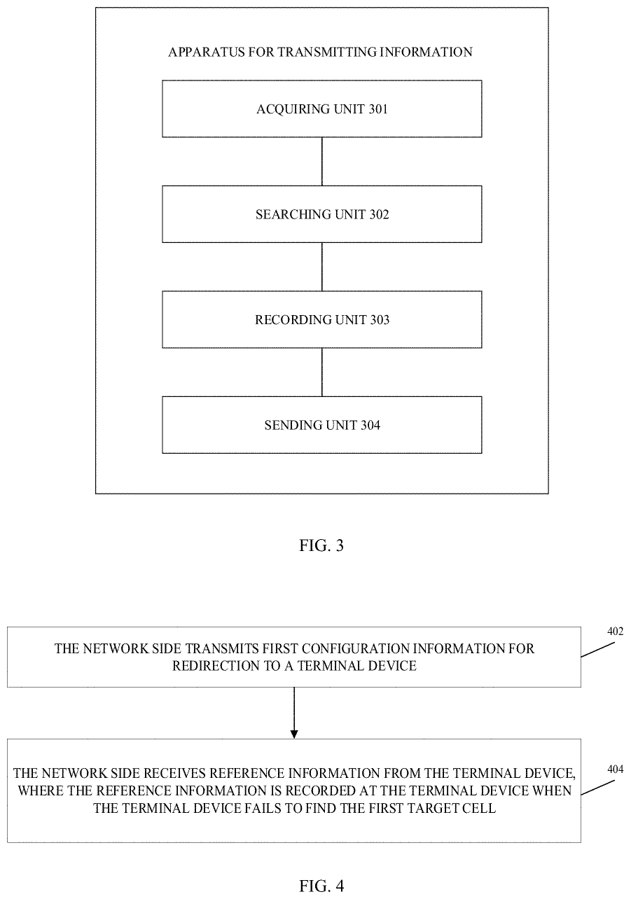

The above has describe the method for transmitting information from the terminal device side. In the following, the method for transmitting information will be described from a network side. FIG. 4 is a flow chart illustrating the method transmitting information, which is applicable to the network side.

As illustrated in FIG. 4, the method begins at block 402.

At block 402, the network side transmits first configuration information for redirection to a terminal device, where the first configuration information is used for the terminal device to search for a first target cell that matches the first configuration information.

In at least one implementation, the network side transmits a radio resource control (RRC) connection release message to the terminal device, and the RRC connection release message carries the first configuration information for redirection.

At block 404, the network side receives reference information from the terminal device, where the reference information is recorded at the terminal device when the terminal device fails to find the first target cell.

The reference information includes at least one of: the first configuration information, identity (ID) information of a second target cell found by the terminal device, location information of the terminal device, timestamp information corresponding to the recording, signal quality of a serving cell, and signal quality of a neighbor cell of the serving cell.

In at least one implementation, the first configuration information comprises at least one of: radio access type (RAT) information of the target cell, frequency information of the target cell, ID information of the target cell, and system broadcast information of the target cell.

For details not provided herein, reference can be made to the foregoing description, and will not be repeated here to avoid redundancy.

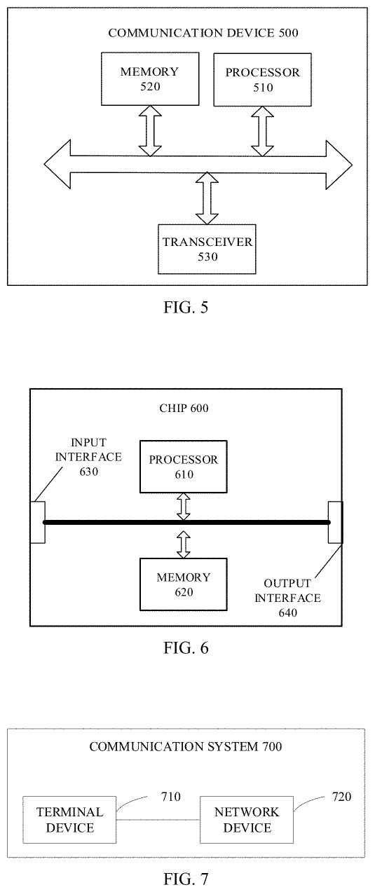

FIG. 5 is a schematic structural diagram of a communication device 500 according to implementations. The communication device may be a terminal device. As illustrated in FIG. 5, the communication device 500 includes a processor 510. The processor 510 can invoke and execute computer programs stored in a memory to perform the method provided in implementations.

As illustrated in FIG. 5, the communication device 500 can further include the memory 520. The processor 510 can invoke and execute the computer programs stored in the memory 520 to perform the method provided in implementations.

The memory 520 may be a separate device independent of the processor 510, or may be integrated into the processor 510.

As illustrated in FIG. 5, the communication device 500 can further include a transceiver 530. The processor 510 can control the transceiver 530 to communicate with other devices, for example, to send information or data to other devices, or to receive information or data from other devices.

The transceiver 530 may include a transmitter and a receiver. The transceiver 530 may further include an antenna, where one or more antennas can be provided.

The communication device 500 may be the network device of implementations, and the communication device 500 can implement the operations performed by the network device described in the foregoing method implementations, which will not be repeated herein for the sake of simplicity.

Alternatively, the communication device 500 may be the mobile terminal/the terminal device of implementations, and the communication device 500 can implement the operations performed by the mobile terminal/the terminal device described in the foregoing method implementations, which will not be repeated herein for the sake of simplicity.

FIG. 6 is a schematic structural diagram of a chip according to implementations. As illustrated in FIG. 6, the chip 600 includes a processor 610. The processor 610 is configured to invoke and execute computer programs stored in a memory to perform the method provided in implementations.

As illustrated in FIG. 6, the chip 600 further includes the memory 620. The processor 610 can invoke and execute the computer programs stored in the memory 620 to perform the method provided in implementations.

The memory 620 may be a separate device independent of the processor 610, or may be integrated into the processor 610.

The chip 600 may further include an input interface 630. The processor 610 can control the input interface 630 to communicate with other devices or chips, for example, to acquire information or data sent by other devices or chips.

The chip 600 may further include an output interface 640. The processor 610 can control the output interface 640 to communicate with other devices or chips, for example, to output information or data to other devices or chips.

The chip is applicable to the network device of implementations. The chip can implement the operations performed by the network device described in the foregoing method implementations, which will not be repeated herein for the sake of simplicity.

Alternatively, the chip is applicable to the mobile terminal/the terminal device. The chip can implement the operations performed by the mobile terminal/the terminal device described in the foregoing method implementations, which will not be repeated herein for the sake of simplicity.

It should be understood that, the chip herein may also be referred to as a system-on-chip (SOC).

FIG. 7 is a schematic block diagram of a communication system 700 according to implementations. As illustrated in FIG. 7, the communication system 700 includes a terminal device 710 and a network device 720.

The terminal device 710 can implement functions of the foregoing methods which are implemented by a terminal device, and the network device 720 can implement functions of the foregoing methods which are implemented by a network device, which will not be repeated herein for the sake of simplicity.

The processor referred to herein may be an integrated circuit chip with signal processing capabilities. During implementation, each step of the foregoing method may be completed by an integrated logic circuit in the form of hardware or an instruction in the form of software in the processor. The processor may be a general-purpose processor, a digital signal processor (DSP), an application specific integrated circuit (ASIC), a field programmable gate array (FPGA), or other programmable logic devices, discrete gates or transistor logic devices, or discrete hardware components, which can implement or execute the methods, steps, and logic blocks disclosed in implementations. The general purpose processor may be a microprocessor, or the processor may be any conventional processor or the like. The steps of the method disclosed in implementations may be implemented through a hardware decoding processor, or may be performed by hardware and software modules in the decoding processor. The software module can be located in a storage medium such as a random access memory (RAM), a flash memory, a read only memory (ROM), a programmable ROM (PROM), or an electrically erasable programmable memory, registers, and the like. The storage medium is located in the memory. The processor reads the information in the memory, and completes the steps of the method described above with the hardware of the processor.

It can be understood that, the memory according to implementations may be a volatile memory or a non-volatile memory, or may include both the volatile memory and the non-volatile memory. The non-volatile memory may be a ROM, a PROM, an erasable programmable read only memory (erasable PROM, EPROM), an electrically erasable programmable read only memory (electrically EPROM, EEPROM), or flash memory. The volatile memory can be a RAM that acts as an external cache. By way of example but not limitation, many forms of RAM are available, such as a static random access memory (static RAM, SRAM), a dynamic random access memory (dynamic RAM, DRAM), a synchronous dynamic random access memory (synchronous DRAM, SDRAM), a double data rate SDRAM (DDR SDRAM), an enhanced SDRAM (ESDRAM), a synchronous link dynamic random access memory (synch-link DRAM, SLDRAM), and a direct rambus random access memory (direct rambus RAM, DRRAM). The memory of the systems and methods described herein is intended to include, but is not limited to, these and any other suitable types of memory.

It should be understood that, the above description of the memory is intended for illustration rather than limitation. For example, the memory of implementations may also be an SRAM, a DRAM, an SDRAM, a DDR SDRAM, an ESDRAM, an SLDRAM, a DR RAM, etc. In other words, the memory of implementations is intended to include, but is not limited to, these and any other suitable types of memory.

Implementations further provide a computer readable storage medium. The computer readable storage medium is configured to store computer programs.

The computer readable storage medium is applicable to the network device of implementations. The computer programs are operable with a computer to implement the operations performed by the network device described in the foregoing method implementations, which will not be repeated herein for the sake of simplicity.

Alternatively, the computer readable storage medium is applicable to the mobile terminal/the terminal device. The computer programs are operable with a computer to implement the operations performed by the mobile terminal/the terminal device described in the foregoing method implementations, which will not be repeated herein for the sake of simplicity.

Implementations further provide a computer program product. The computer program product includes computer program instructions.

The computer program product is applicable to the network device of implementations. The computer program instructions are operable with a computer to implement the operations performed by the network device described in the foregoing method implementations, which will not be repeated herein for the sake of simplicity.

Alternatively, the computer program product is applicable to the mobile terminal/the terminal device. The computer program instructions are operable with a computer to implement the operations performed by the mobile terminal/the terminal device described in the foregoing method implementations, which will not be repeated herein for the sake of simplicity.

Implementations further provide a computer program.

The computer program is applicable to the network device of implementations. The computer program, when executed by a computer, is operable with the computer to implement the operations performed by the network device described in the foregoing method implementations, which will not be repeated herein for the sake of simplicity.

Alternatively, the computer program is applicable to the mobile terminal/the terminal device. The computer program, when executed by a computer, is operable with the computer to implement the operations performed by the mobile terminal/the terminal device described in the foregoing method implementations, which will not be repeated herein for the sake of simplicity.

Those of ordinary skill in the art will appreciate that units and algorithmic operations of various examples described in connection with implementations herein can be implemented by electronic hardware or by a combination of computer software and electronic hardware. Whether these functions are performed by means of hardware or software depends on the application and the design constraints of the associated technical solution. Those skilled in the art may use different methods with regard to each particular application to implement the described functionality, but such methods should not be regarded as lying beyond the scope of the disclosure.

It will be evident to those skilled in the art that, for the sake of convenience and simplicity, in terms of the working processes of the foregoing systems, apparatuses, and units, reference can be made to the corresponding processes of the above method implementations, which will not be repeated herein.

It will be appreciated that the systems, apparatuses, and methods disclosed in implementations herein may also be implemented in various other manners. For example, the above apparatus implementations are merely illustrative, e.g., the division of units is only a division of logical functions, and other manners of division may also available in practice, e.g., multiple units or assemblies may be combined or may be integrated into another system, or some features may be ignored or omitted. In other respects, the coupling or direct coupling or communication connection as illustrated or discussed may be an indirect coupling or communication connection through some interface, device or unit, and may be electrical, mechanical, or otherwise.

Separated units as illustrated may or may not be physically separated. Components or parts displayed as units may or may not be physical units, and may reside at one location or may be distributed to multiple networked units. Some or all of the units may be selectively adopted according to practical needs to achieve desired objectives of the disclosure.

Various functional units described in implementations herein may be integrated into one processing unit or may be present as a number of physically separated units, and two or more units may be integrated into one.

If the integrated units are implemented as software functional units and sold or used as standalone products, they may be stored in a computer readable storage medium. Based on such an understanding, the essential technical solution, or the portion that contributes to the prior art, or part of the technical solution of the disclosure may be embodied as software products. The computer software products can be stored in a storage medium and may include multiple instructions that, when executed, can cause a computing device, e.g., a personal computer, a server, a network device, etc., to execute some or all operations of the methods described in various implementations. The above storage medium may include various kinds of media that can store program codes, such as a universal serial bus (USB) flash disk, a mobile hard drive, a ROM, a RAM, a magnetic disk, or an optical disk.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for transmitting information, applicable to a terminal device and comprising:
acquiring first configuration information for redirection, and searching for a target cell based on the first configuration information;
recording reference information, when the terminal device fails to find a first target cell which matches the first configuration information, wherein the reference information comprises at least one of: the first configuration information, identity (ID) information of a second target cell found by the terminal device, location information of the terminal device, timestamp information corresponding to the recording, signal quality of a serving cell, and signal quality of a neighbor cell of the serving cell; and
sending the recorded reference information to a network side.

2. The method of claim 1, wherein acquiring the first configuration information for redirection comprises:
receiving a radio resource control (RRC) connection release message from the serving cell, wherein the RRC connection release message carries the first configuration information for redirection.

3. The method of claim 1, wherein the first configuration information comprises at least one of: radio access type (RAT) information of the target cell, frequency information of the target cell, ID information of the target cell, and system broadcast information of the target cell.

4. The method of claim 1, wherein the ID information of the second target cell comprises at least one of: cell identifier (CID), physical cell identifier (PCI), RAT, frequency, and public land mobile network (PLMN) list.

5. The method of claim 1, wherein the location information of the terminal device comprises at least one of: geographical location information of the terminal device, and measurement results for neighbor cells of the serving cell.

6. The method of claim 5, wherein the geographical location information of the terminal device comprises at least one of: longitude information, latitude information, and altitude information.

7. The method of claim 1, wherein the first configuration information further comprises duration information of a first timer, and the method further comprises:
after acquiring the first configuration information, starting the first timer.

8. The method of claim 7, further comprising:
when the terminal device fails to find, before the first timer expires, a target cell that can be connected,
entering an idle state, even if the terminal device finds, after the first timer expires, the target cell that can be connected.

9. The method of claim 1, wherein sending the recorded reference information to the network side comprises:
sending the recorded reference information to the network side, after the terminal device enters an RRC connected state.

10. An apparatus for transmitting information, being applicable to a terminal device and comprising:
at least one processor;
a transceiver; and
a memory storing instructions which, when executed by the at least one processor, cause the at least one processor to:
acquire, through the transceiver, first configuration information for redirection;
search for a target cell based on the first configuration information;
record reference information when failing to find a first target cell which matches the first configuration information, wherein the reference information comprises at least one of: the first configuration information, identity (ID) information of a second target cell found by the terminal device, location information of the terminal device, timestamp information corresponding to the recording, signal quality of a serving cell, and signal quality of a neighbor cell of the serving cell; and
send, through the transceiver, the recorded reference information to a network side.

11. The apparatus of claim 10, wherein the transceiver is configured to:
receive a radio resource control (RRC) connection release message from the serving cell, wherein the RRC connection release message carries the first configuration information for redirection.

12. The apparatus of claim 10, wherein the timestamp information comprises at least one of:
absolute time information local to the terminal device when the terminal device records the reference information; and
relative time information relative to a reference time when the terminal device records the reference information, wherein the reference time is configured at the network side.

13. The apparatus of claim 10, wherein the signal quality of a serving cell comprises at least one of: reference signal receiving power (RSRP), reference signal receiving quality (RSRQ), and signal to interference plus noise ratio (SINK).

14. The apparatus of claim 10, wherein the signal quality of a neighbor cell of the serving cell comprises at least one of: RSRP, RSRQ, and SINR.

15. The apparatus of claim 10, wherein the first configuration information further comprises duration information of a first timer, and the processor is further configured to:
start the first timer after the first configuration information is acquired.

16. The apparatus of claim 15, wherein the processor is configured to control the terminal device to enter an idle state, in response to that a target cell that can be connected is found after rather than before the first timer expires.

17. The apparatus of claim 10, wherein the transceiver is configured to:
send the recorded reference information to the network side, after the terminal device enters an RRC connected state.

18. A method for transmitting information, applicable to a network side and comprising:
transmitting first configuration information for redirection to a terminal device, wherein the first configuration information is used for the terminal device to search for a first target cell that matches the first configuration information; and
receiving reference information from the terminal device, wherein the reference information is recorded at the terminal device when the terminal device fails to find the first target cell, wherein the reference information comprises at least one of: the first configuration information, identity (ID) information of a second target cell found by the terminal device, location information of the terminal device, timestamp information corresponding to the recording, signal quality of a serving cell, and signal quality of a neighbor cell of the serving cell.

19. The method of claim 18, wherein transmitting the first configuration information for redirection to the terminal device comprises:
transmitting a radio resource control (RRC) connection release message to the terminal device, wherein the RRC connection release message carries the first configuration information for redirection.

20. The method of claim 18, wherein the first configuration information comprises at least one of: radio access type (RAT) information of the target cell, frequency information of the target cell, ID information of the target cell, and system broadcast information of the target cell.
